(19) United States
(12) Patent Application Publication
(10) Pub. No.: US 2023/0229507 A1
(43) Pub. Date: Jul. 20, 2023

(54) SCHEDULING COMPUTATIONS IN DEEP NEURAL NETWORK BASED ON SPARSITY

(71) Applicant: Intel Corporation, Santa Clara, CA (US)

(72) Inventors: Raymond Jit-Hung Sung, San Francisco, CA (US); Arnab Raha, San Jose, CA (US); Deepak Abraham Mathaikutty, Chandler, AZ (US); Umer Iftikhar Cheema, Hillsboro, OR (US)

(73) Assignee: Intel Corporation, Santa Clara, CA (US)

(21) Appl. No.: 18/180,415

(22) Filed: Mar. 8, 2023

(51) Int. Cl. G06F 9/50; G06N 3/04

(52) U.S. Cl. CPC G06F 9/5027; G06N 3/04; H04L 41/16

(57) ABSTRACT

Computations in processing elements (PEs) for executing a deep neural network are scheduled via a computation scheduler based on sparsity in input data of the computations to reduce voltage droops. Each PE may compute an input operand and a weight operand in a computation. The computation scheduler may predict the workload of the PE for the computation based on a combined sparsity bitmap, which may be generated based on a sparsity bitmap of the input operand and a sparsity bitmap of the weight operand. The computation scheduler can schedule the starts of the computations in the PEs based on the predicted workloads of the PEs. The computation scheduler may instruct the PE having the highest workload to start the computation first and instruct the other PEs to start computations later. In some embodiments, the computations in the PEs may end in the same clock cycle.

### TECHNICAL FIELD

This disclosure relates generally to neural networks, and more specifically, scheduling computations in deep neural networks (DNNs) based on sparsity.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. () 1 illustrates an example DNN, in accordance with various embodiments.

FIG. 2 illustrates an example convolution, in accordance with various embodiments.

FIG. 3 is a block diagram of a DNN accelerator, in accordance with various embodiments.

FIG. 4 is a block diagram of a compute block, in accordance with various embodiments.

FIG. 5 illustrates a processing element (PE) array, in accordance with various embodiments.

FIG. 6 is a block diagram of a PE, in accordance with various embodiments.

FIG. 7 illustrates sparsity acceleration in an MAC operation by a PE, in accordance with various embodiments.

FIG. 8 illustrates a computation schedule for a group of PEs, in which computations by the PEs start at the same time, in accordance with various embodiments.

FIG. 9 illustrates a computation schedule for a group of PEs that can reduce voltage droop, in accordance with various embodiments.

FIG. 10 illustrates another computation schedule for a group of PEs that can reduce voltage droop, in accordance with various embodiments.

FIG. 11 is a flowchart showing a method of scheduling computations in a DNN, in accordance with various embodiments.

FIG. 12 is a block diagram of an example computing device, in accordance with various embodiments.

### DETAILED DESCRIPTION

### Overview

The last decade has witnessed a rapid rise in Al (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

An accelerator for DNN (“DNN accelerator”) may include one or more large arrays of PEs which operate concurrently in executing the layers in a DNN. The simultaneous start of the computations in the DNN (e.g., MAC operations) can cause fast and large activity transitions that can induce large current transients. Such large current transients can cause significant voltage droops that degrade the system performance. Voltage droops may also lead to functional failures. Simultaneous starting of computations can occur per compute round. Therefore, voltage droop is a commonly occurring event in DNN accelerators.

A currently available design applies a voltage guard band by operating supply voltage higher than the minimum voltage. Another currently available design applies a clock frequency (F_{CLK}) guard band by operating F_{CLK} lower than the maximum F_{CLK} to ensure correct functionality during voltage droop events. However, these additional guard bands can reduce the system performance during operation in some common cycles of operation.

A currently available solution for reducing voltage droop is to stagger the executions of the functional units or individual arithmetic components to smooth the transient current demand. Taking a DNN accelerator that includes PEs for example, the computations in the PEs can be simultaneously activated, which can cause a large simultaneous current demand. The currently available solution can facilitate staggered computations in the PEs by delaying the computations in the PEs by a predetermined increment of time. For instance, the start of computations of individual PEs can be delayed by increments of ΔT, so that every PE may start its computation at a different time. However, the staggering of the computations is usually done without considering input data patterns or the instructions that triggered the computations. One of the disadvantages of staggered computations is that the time to finish the computations can be delayed and hence the throughput performance of the DNN accelerator can be adversely affected.

Some other solutions for reducing voltage droop apply adaptive circuit techniques to reduce the effect of voltage droops on system performance by measuring supply voltage variation with an on-die monitor and adjusting F_{CLK}. Such reactive techniques require a response time to detect the voltage droop and to adapt the F_{CLK} to avoid a critical-path timing-margin failure. However, even though these techniques are low-overhead, they fail to be effective at mitigating the impact of high-frequency voltage droops. Other adaptive techniques that can address the response time are adaptive frequency systems. These adaptive frequency systems can directly modulate the phase-locked-loop (PLL) clock output to adapt F_{CLK} as V_{DD} varies. However, analog circuits for such adaptive frequency systems can be complicated. To avoid complicated analog circuits, digital adaptive clock distribution is adopted. The digital adaptive clock distribution can use a tunable-length delay between the PLL and global clock distribution to exploit temporary clock against data path compensation during a voltage droop. This can provide an acceptable response time during which the clock frequency may be adaptively reduced without affecting the system performance. However, performance of this system is not uniform across all frequency points and since many DNN accelerators operate over a very large frequency range and often scales voltage and frequency dynamically (DVFS), it does not perform well across the entire operation range. Some other adaptive designs combine both V_{DD} and F_{CLK} into a single control loop. Although such a control loop can enable infinite clock-data compensation, there is a challenge in developing practical and efficient V_{DD} regulators for such a system.

Another solution for reducing voltage droop is based on a recover technique. Resilient timing-error detection and recovery circuits are used to relax the response-time constraint by detecting a timing-margin violation caused by a voltage droop, isolating the error from corrupting the architectural state, and correcting the error through the recovery technique. Error correction can take place over multiple clock cycles since the architectural state is preserved. Although this technique can be effective at high frequencies, the design complexity of implementing error recovery while ensuring coverage for all failure scenarios is a significant hurdle.

Embodiments of the present disclosure may improve on at least some of the challenges and issues described above by reducing voltage droops in DNN accelerators based on sparsity in input data of computations in DNNs. Input data of DNN layers (e.g., convolutional layers, etc.) may include weighs and activations. Activations or weights of a DNN layer may be arranged in a tensor. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. The weights may be determining by training the DNN. The activations may be data elements in an input to the DNN (e.g., in embodiments where the DNN layer is the first layer of the DNN) or data elements generated in a previous layer of the DNN.

A DNN layer may have a significant number of zero-valued weights (i.e., weights having values of zero), which may be generated during the training phase. Zero-valued weights do not contribute towards partial sum accumulation during MAC operations in convolution. Sparse weights can cause activations to become sparse in subsequent layers of the DNN. Network quantization for running inference on edge devices can also result in a high number of zeros in weight and activations. Further, non-linear activation functions, such as the rectified linear activation function (ReLU), can clamp negative valued activation to zero and are commonly exist in DNNs. DNN accelerators can achieve significant acceleration in computations by skipping zeros during MAC operations in convolution. Various embodiments of the present disclosure can further take advantage of the presence of sparsity in weights and activations to reduce voltage droops in DNN accelerators.

In some embodiments, a scheduler is associated with a group of PEs in a DNN accelerator. The scheduler can schedule the start of computations in the group of PEs based on sparsity in activations and weights to be computed by the PEs. The group of PEs may be an entire array of PEs, multiple arrays of PEs, a column of PEs in an array, a portion of a column of PEs, and so on. For instance, a PE is to perform a MAC operation on an activation operand and a weight operand. The activation operand may include a sequence of activations, each of which may be a data element in an input tensor (e.g., input feature map (IFM)) of a DNN layer. The weight operand may include a sequence of weights, each of which may be a data element in a filter of the DNN layer. The activation operand is associated with an activation sparsity bitmap that includes a sequence of bits. Each bit corresponds to a respective activation in the activation operand and indicates whether the value of the activation is zero or non-zero. The weight operand is associated with a weight sparsity bitmap that includes a sequence of bits. Each bit in the weight sparsity bitmap corresponds to a respective weight in the weight operand and indicates whether the value of the weight is zero or non-zero. A combined sparsity bitmap may be generated based on the activation sparsity bitmap and the weight sparsity bitmap. The combined sparsity bitmap includes a sequence of bits, each of which corresponds to a respective activation and weight. For a bit corresponding to a nonzero-valued activation and a nonzero-valued weight, the value of the bit may be one. For a bit corresponding to a zero-valued activation or zero-valued weight, the value of the bit may be zero.

The PEs can skip computations of zero-valued activation and zero-valued weight based on the combined sparsity bitmaps. For instance, nonzero-valued activations and nonzero-valued weights can be identified based on the combined sparsity bitmaps and loaded to the PEs for computations. The scheduler can predict the workloads of the PEs based on the number of non-zero bits in the combined sparsity bitmaps. The scheduler may determine the start of the computations by the PEs based on the predicted workloads so that computations in PEs with different workloads can start at different times, which can avoid large current transients in the DNN accelerator. Moreover, as the scheduler knows the workloads of the PEs, the scheduler can determine the start of the computations by the PEs in a way to avoid sacrificing the throughout performance of the DNN accelerator by making sure that none of the computations will end later than the computation in the PE having the largest workload. In some embodiments, the scheduler may make the computations of the PEs end at the same time. In other embodiments, the computations of the PEs may end at different times.

The scheduler may determine a workload score for each of the PEs. The workload score of a PE may equal the number of non-zero bits in the combined sparsity bitmap of the PE. A down counter may count down from the highest workload score towards a lower number (e.g., the lowest workload score or zero) with a fixed increment (e.g., one) through a sequence of clock cycles. The down counter has a different number for every respective clock cycle. The scheduler may instruct a PE to start its computation in a cycle that is after (e.g., immediately after) the cycle in which the number at the down counter matches the workload score of the PE.

As the scheduler can schedule the starts of the computations in the PEs for different times, large current transients, and voltage droops in the DNN accelerator can be reduced. The scheduler can also ensure that the other PEs finish their computations no later than the PE having the highest workload so that the benefit of the sparsity acceleration in the DNN accelerator can be kept. The scheduler may be scalable across one or more columns PEs in a PE array. Furthermore, the scheduler may be scalable across multiple PE arrays. Each scheduler can operate independently on its assigned PEs and do not have to communicate with each other. Furthermore, the compiler that determines how DNN layers are executed in the DNN accelerator (or across multiple DNN accelerators) would not require re-layout of activations or weights in memory. Compared with currently available techniques, the present disclosure provides a more advantageous technique for reducing voltage droops and improving efficiency in DNN accelerators.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/- 20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/- 5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

FIG. 1 illustrates an example DNN 100, in accordance with various embodiments. For purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is ReLU. ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

### Example Convolution

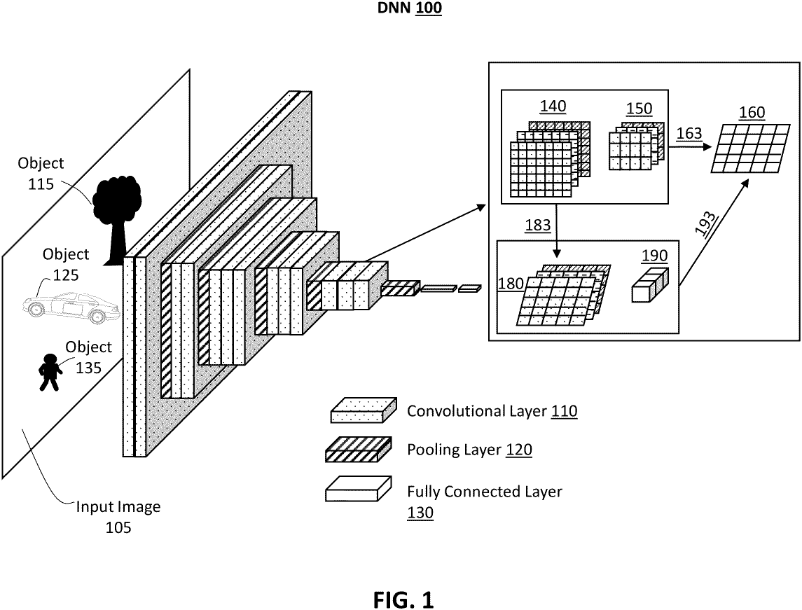

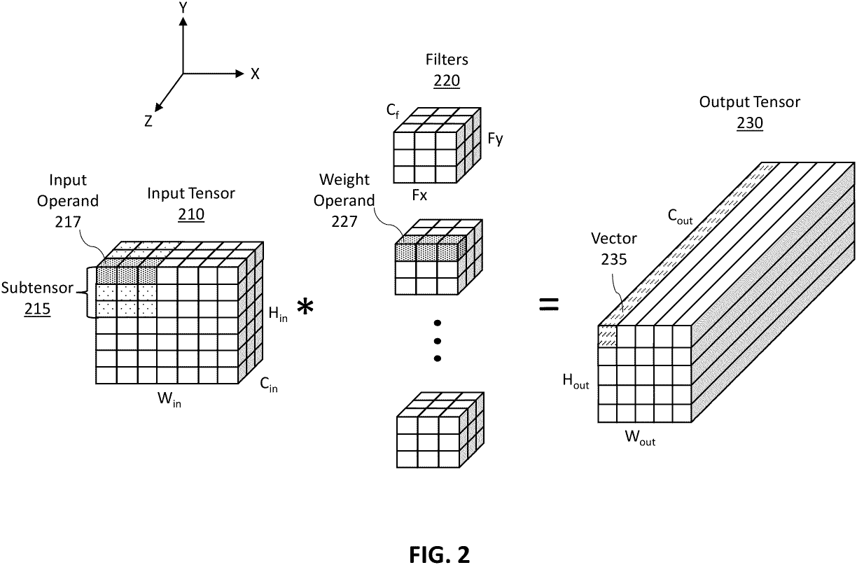

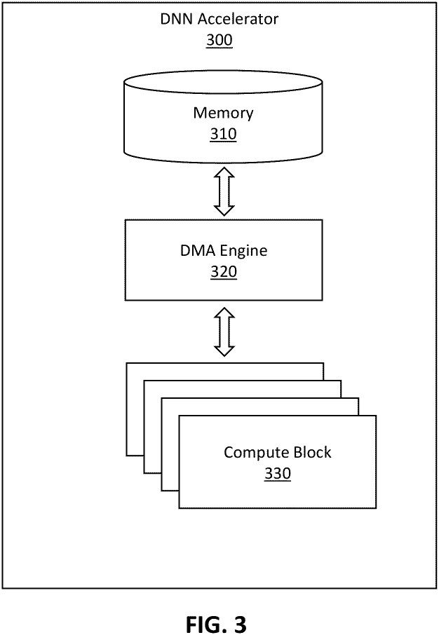

FIG. 2 illustrates an example convolution, in accordance with various embodiments. The convolution may be a convolution in a convolutional layer of a DNN, e.g., a convolutional layer 110 in FIG. 1. The convolutional layer may be a frontend layer. The convolution can be executed on an input tensor 210 and filters 220 (individually referred to as “filter 220”). A result of the convolution is an output tensor 230. In some embodiments, the convolution is performed by a DNN accelerator including one or more compute block. An example of the DNN accelerator may be the DNN accelerator 300 in FIG. 3. Examples of the compute blocks may be the compute blocks 325 in FIG. 3.

In the embodiments of FIG. 2, the input tensor 210 includes activations (also referred to as “input activations,” “elements,” or “input elements”) arranged in a 3D matrix. An activation in the input tensor 210 is a data point in the input tensor 210. The input tensor 210 has a spatial size Hᵢₙ × Wiₙ × Cᵢₙ, where Hᵢₙ is the height of the 3D matrix (i.e., the length along the Y axis, which indicates the number of activations in a column in the 2D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{ƒ} × W_{ƒ} × C_{ƒ}, where H_{ƒ} is the height of the filter (i.e., the length along the Y axis, which indicates the number of weights in a column in each kernel), W_{ƒ} is the width of the filter (i.e., the length along the X axis, which indicates the number of weights in a row in each kernel), and C_{ƒ} is the depth of the filter (i.e., the length along the Z axis, which indicates the number of channels). In some embodiments, C_{ƒ} equals Cᵢₙ. For purpose of simplicity and illustration, each filter 220 in FIG. 2 has a spatial size of 3×3×3, i.e., the filter 220 includes 3 convolutional kernels with a spatial size of 3×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has an integral format (e.g., INT8), the activation takes one byte. When the activation or weight has a floating-point format (e.g., FP16 or BF16), the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An activation in the output tensor 230 is a data point in the output tensor 230. The output tensor 230 has a spatial size Hₒᵤₜ × Wₒᵤₜ × Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 220 in the convolution. Hₒᵤₜ and Wₒᵤₜ may depend on the heights and weights of the input tensor 210 and each filter 220.

As a part of the convolution, MAC operations can be performed on a 3×3×3 subtensor 215 (which is highlighted with dot patterns in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (x, y) coordinate, but the output activations correspond to different output channels and have different Z coordinates. The dimension of the vector 235 along the Z axis may equal the total number of output channels in the output tensor 230.

After the vector 235 is produced, further MAC operations are performed to produce additional vectors till the output tensor 230 is produced. For instance, a filter 220 may move over the input tensor 210 along the X axis or the Y axis, and MAC operations can be performed on the filter 220 and another subtensor in the input tensor 210 (the subtensor has the same size as the filter 220). The amount of movement of a filter 220 over the input tensor 210 during different compute rounds of the convolution is referred to as the stride size of the convolution. The stride size may be 1 (i.e., the amount of movement of the filter 220 is one activation), 2 (i.e., the amount of movement of the filter 220 is two activations), and so on. The height and width of the output tensor 230 may be determined based on the stride size.

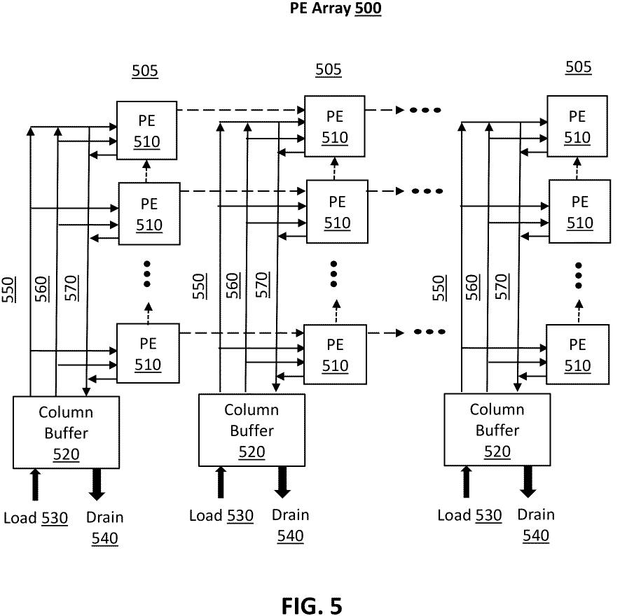

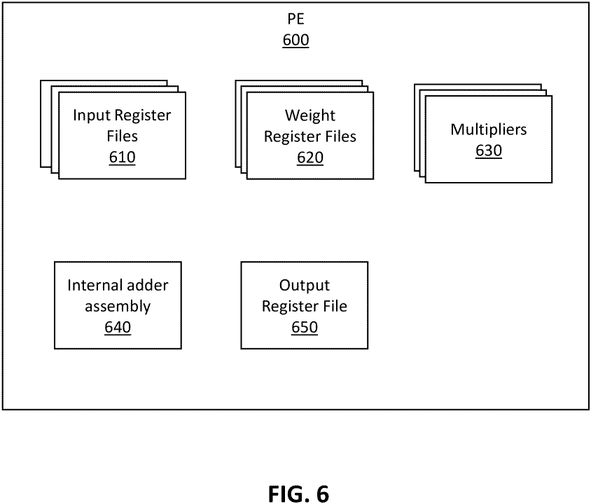

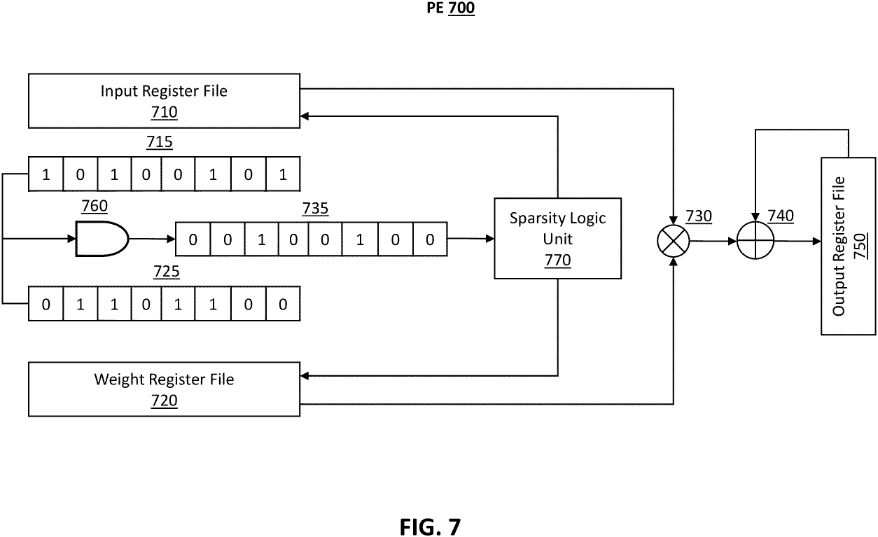

In some embodiments, the MAC operations on a 3×3×3 subtensor (e.g., the subtensor 215) and a filter 220 may be performed by a plurality of PEs, such as the PEs 510 in FIG. 5, the PE 600 in FIG. 6, or the PE 700 in FIG. 7. One or more MAC units may receive an input operand (e.g., an input operand 217 shown in FIG. 2) and a weight operand (e.g., the weight operand 227 shown in FIG. 2). The input operand 217 includes a sequence of activations having the same (Y, Z) coordinate but different X coordinates. The weight operand 227 includes a sequence of weights having the same (Y, Z) coordinate but different X coordinates. The length of the input operand 217 is the same as the length of the weight operand 227. Activations in the input operand 217 and weights in the weight operand 227 may be sequentially fed into a PE. The PE may receive a pair of an activation and a weight at a time and multiple the activation and the weight. The position of the activation in the input operand 217 may match the position of the weight in the weight operand 227.

### Example DNN Accelerator

FIG. 3 is a block diagram of a DNN accelerator 300, in accordance with various embodiments. The DNN accelerator 300 can run DNNs, e.g., the DNN 100 in FIG. 1. The DNN accelerator 300 includes a memory 310, a DMA (direct memory access) engine 320, and compute blocks 330. In other embodiments, alternative configurations, different or additional components may be included in the DNN accelerator 300. For example, the DNN accelerator 300 may include more than one memory 310 or more than one DMA engine 320. As another example, the DNN accelerator 300 may include a single compute block 330. Further, functionality attributed to a component of the DNN accelerator 300 may be accomplished by a different component included in the DNN accelerator 300 or by a different system.

The memory 310 stores data to be used by the compute blocks 330 to perform deep learning operations in DNN models. Example deep learning operations include convolutions (also referred to as “convolutional operations”), pooling operations, elementwise operations, other types of deep learning operations, or some combination thereof. The memory 310 may be a main memory of the DNN accelerator 300. In some embodiments, the memory 310 includes one or more DRAMs (dynamic random-access memory). For instance, the memory 310 may store the input tensor, convolutional kernels, or output tensor of a convolution in a convolutional layer of a DNN, e.g., the convolutional layer 30. The output tensor can be transmitted from a local memory of a compute block 330 to the memory 310 through the DMA engine 320.

The DMA engine 320 facilitates data transfer between the memory 310 and local memories of the compute blocks 330. For example, the DMA engine 320 can read data from the memory 310 and write data into a local memory of a compute block 330. As another example, the DMA engine 320 can read data from a local memory of a compute block 330and write data into the memory 310. The DMA engine 320 provides a DMA feature that allows the compute block 330 to initiate data transfer between the memory 310 and the local memories of the compute blocks 330 and to perform other operations while the data transfer is in being conducted. In some embodiments, the DMA engine 320 may read tensors from the memory 310, modify the tensors in a way that is optimized for the compute block 330 before it writes the tensors into the local memories of the compute blocks 330.

The compute blocks 330 perform computation for deep learning operations. A compute block 330 may run the operations in a DNN layer, or a portion of the operations in the DNN layer. A compute block 330 may perform convolutions, such as standard convolution (e.g., the standard convolution 163 in FIG. 1), depthwise convolution (e.g., the depthwise convolution 183 in FIG. 1), pointwise convolution (e.g., the pointwise convolution 193 in FIG. 1), and so on. In some embodiments, the compute block 330 receive an input tensor and one or more convolutional kernels and performs a convolution with the input tensor and convolutional kernels. The result of the convolution may be an output tensor, which can be further computed, e.g., by the compute block 330 or another compute block. In some embodiments, the operations of the DNN layers may be run by multiple compute blocks 330 in parallel. For instance, multiple compute blocks 330 may each perform a portion of a workload for a convolution. Data may be shared between the compute blocks 330.

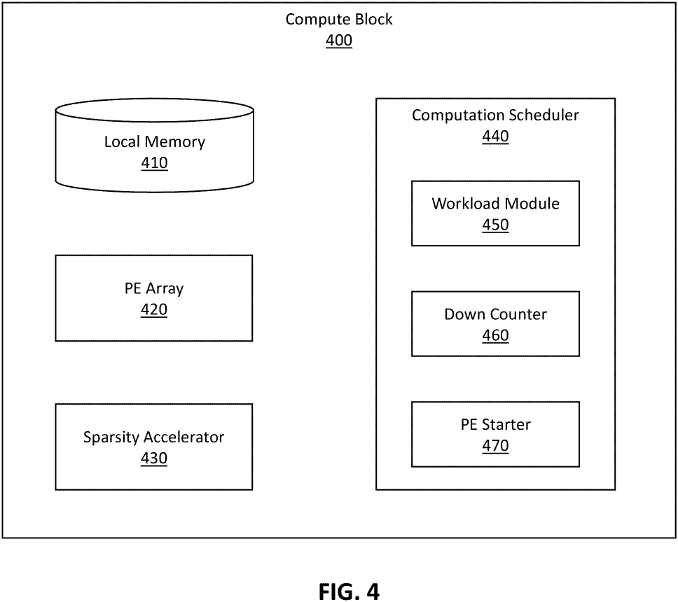

FIG. 4 is a block diagram of a compute block 400, in accordance with various embodiments. The compute block 400 may be an example of the compute block 330 in FIG. 3. As shown in FIG. 4, the compute block 400 includes a local memory 410, a PE array 420, a sparsity accelerator 430, and a computation scheduler 440. In other embodiments, alternative configurations, different or additional components may be included in the compute block 400. For instance, the compute block 400 may include more than one local memory 410, PE array 420, sparsity accelerator 430, or computation scheduler 440. Further, functionality attributed to a component of the compute block 400 may be accomplished by a different component included in the compute block 400, another component of the DNN accelerator 300, or by a different system.

The local memory 410 is local to the compute block 400. In the embodiments of FIG. 4, the local memory 410 is inside the compute block 400. In other embodiments, the local memory 410 may be outside the compute block 400. The local memory 410 and the compute block 400 can be implemented on the same chip. The local memory 410 stores data used for or generated from convolutions, e.g., input activations, weights, and output activations. In some embodiments, the local memory 410 includes one or more SRAMs (static random-access memories). The local memory 410 may be byte-addressable, and each memory address identifies a single byte (eight bits) of storage. In some embodiments, the local memory 410 may include banks, each bank may have a capacity of a fixed number of bytes, such as 32, 64, and so on.

The PE array 420 performs MAC operations in convolutions. The PE array 420 may perform other deep learning operations. The PE array 420 may include PEs arranged in columns, or columns and rows. Each PE can perform MAC operations. In some embodiments, a PE includes one or more multipliers for performing multiplications. An PE may also include one or more adders for performing accumulations. A column of PEs is referred to as a PE column. A PE column may be associated with one or more MAC lanes. A MAC lane is a path for loading data into a MAC column. A MAC lane may be also referred to as a data transmission lane or data load lane. A PE column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where a MAC column has four MAC lanes for feeding activations or weights into the MAC column and each MAC lane may have a bandwidth of 16 bytes, the four MAC lanes can have a total loading bandwidth of 64 bytes.

In some embodiments, the PE array 420 may be capable of standard convolution, depthwise convolution, pointwise convolution, other types of convolutions, or some combination thereof. In a depthwise convolution, a PE may perform an MAC operation that include a sequence of multiplications for an input operand (e.g., the input operand 217) and a weight operand (e.g., the weight operand 227). Each multiplication in the sequence is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 420 may output multiple output operands at a time, each of which is generated by a different PE. In a standard convolution, MAC operations may include accumulations across the channels. For instance, as opposed to generating an output operand, a PE may accumulate products across different channels to generate a single output point.

In some embodiments, a PE may perform multiple rounds of MAC operations for a convolution. Data (activations, weights, or both) may be reused within a single round, e.g., across different multipliers in the PE, or reused across different rounds of MAC operations. More details regarding PE array are described below in conjunction with FIGS. 5 and 6.

The sparsity accelerator 430 accelerates computations in the PE array 420 based on sparsity in input data of the computations. Even though FIG. 4 shows a single sparsity accelerator 430, the compute block 400 may include multiple sparsity accelerators 430. In some embodiments, every PE in the PE array 420 is implemented with a sparsity accelerator 430 for acceleration computations in the individual PE. In other embodiments, a subset of the PE array 420 (e.g., a PE column or multiple PE columns in the PE array 420) may be implemented with a sparsity accelerator 430 for acceleration computations in the subset of PEs.

In some embodiments (e.g., embodiments where the compute block 400 executes a convolutional layer), a computation in a PE may be a MAC operation on an input operand and a weight operand. The input operand may be a portion of the input tensor of the convolution. The input operand includes a sequence of input elements, aka activations. The activations may be from different input channels. For instance, each activation is from a different input channel from all the other activations in the input operand. The input operand is associated with an input bitmap, which may be stored in the local memory 410. The input bitmap can indicate positions of the nonzero-valued activations in the input operand. The input bitmap may include a sequence of bits, each of which corresponds to a respective activation in the input operand. The position of a bit in the input bitmap may match the position of the corresponding activation in the input operand. A bit in the input bitmap may be zero or one. A zero-valued bit indicates that the value of the corresponding activation is zero, a one valued bit indicates that the value of the corresponding activation is non-zero. In some embodiments, the input bitmap may be generated during the execution of another DNN layer, e.g., a layer that is arranged before the convolutional layer in the DNN.

The weight operand may be a portion of a kernel of the convolution. The weight operand includes a sequence of weights. The values of the weights are determined through training the DNN. The weights in the weight operand may be from different input channels. For instance, each weight is from a different input channel from all the other weights in the weight operand. The weight operand is associated with a weight bitmap, which may be stored in the local memory 410. The weight bitmap can indicate positions of the nonzero-valued weights in the weight operand. The weight bitmap may include a sequence of bits, each of which corresponds to a respective weight in the weight operand. The position of a bit in the weight bitmap may match the position of the corresponding weight in the weight operand. A bit in the weight bitmap may be zero or one. A zero-valued bit indicates that the value of the corresponding weight is zero, a one valued bit indicates that the value of the corresponding weight is non-zero.

The sparsity accelerator 430 may receive the input bitmap and the weight bitmap and generate a combined sparsity bitmap for the MAC operation to be performed by the PE. In some embodiments, the sparsity accelerator 430 generates the combined sparsity bitmap 735 by performing one or more AND operations on the input bitmap and the weight bitmap. Each bit in the combined sparsity bitmap is a result of an AND operation on a bit in the input bitmap and a bit in the weight bitmap, i.e., a product of the bit in the input bitmap and the bit in the weight bitmap. The position of the bit in the combined sparsity bitmap matches the position of the bit in the input bitmap and the position of the bit in the weight bitmap. A bit in the combined bitmap corresponds to a pair of activation and weight (activation-weight pair). A zero bit in the combined sparsity bitmap indicates that at least one of the activation and weight in the pair is zero. A one bit in the combined sparsity bitmap indicates that both the activation and weight in the pair are non-zero. The combined sparsity bitmap may be stored in the local memory 410.

The sparsity accelerator 430 may provide activations and weights to the PE based on the combined sparsity bitmap. For instance, the sparsity accelerator 430 may identify activations and weights corresponding to the ones in the combined sparsity bitmap and forward these activations and weights to the PE. The sparsity accelerator 430 may skip the other activations and the other weights, as they will not contribute to the result of the MAC operation. In some embodiments, the local memory 310 may store the non-zero activations and weights and not store the zero activations or weights. The non-zero activations and weights may be loaded to one or more register files of the PE, from which the sparsity accelerator 430 may retrieve the activations and weights corresponding to the ones in the combined sparsity bitmap. In some embodiments, the total number of ones in the combined sparsity bitmap equals the total number of activation-weight pairs that will be computed by the PE, while the PE does not compute the other activation-weight pairs. By skipping the activation-weight pairs corresponding to zero bits in the combined sparsity bitmap, the computation of the PE will be faster, compared with the PE computing all the activation-weight pairs in the input operand and weight operand.

The computation scheduler 440 schedules computations of some or all the PEs in the PE array 420 based on sparsity in data to be computed by the PEs. The PEs may be a portion of a column in the PE array 420 or may constitute one or more columns or even the entire PE array. In some embodiments, the computation scheduler 440 may be associated with one or more other PE arrays and can schedule computations in multiple PE arrays. As shown in FIG. 4, the computation scheduler 440 includes a workload module 450, a down counter 460, and a PE starter 470. In other embodiments, alternative configurations, different or additional components may be included in the computation scheduler 440. Further, functionality attributed to a component of the computation scheduler 440 may be accomplished by a different component included in the computation scheduler 440, another component of the compute block 400 or the DNN accelerator 300, or by a different system.

The workload module 450 predicts workloads of the PEs based on combined sparsity bitmaps of the PEs, such as combined sparsity bitmaps generated by the sparsity accelerator 430. For each PE, the workload module 450 may determine a workload score that indicates the amount of computation to be performed by the PE. In some embodiments, the workload score may equal the number of ones in the combined sparsity bitmap of the PE. The workload score may also indicate the amount of time needed by the PE to perform the computation, e.g., the time from the start of the computation to the end of the computation. In some embodiments, the workload module 450 may also rank the workload scores of the PEs. The workload module 450 may identify the highest workload score from some or all the workload scores. The workload module 450 may also identify the lowest workload score from some or all the workload scores.

The down counter 460 counts down from a higher number to a lower number through a sequence of clock cycles. In some embodiments, the down counter 460 may count down from the highest workload score towards the lowest workload score. In other embodiments, the down counter 460 may count down from the highest workload score towards zero. The down counter 460 may count a single number in a single clock cycle. The next number for the next clock cycle may equal the number minus one. In an example where the highest workload score is N (N may be an integer), the down counter 460 has N in the first clock cycle, N-1 in the second clock cycle, N-2 in the third clock cycle, and so on. This may continue till the down counter 460 reaches the lowest workload score or zero. For any PE that has a workload score lower than the highest workload score, the down counter 460 can reach the workload score of the PE in one of the clock cycles after the first clock cycle.

The PE starter 470 instructs the PEs to start computations based on the numbers counted by the down counter 460. In some embodiments, the PE starter 470 instructs the PE(s) having the highest workload score to start computation before all the other PEs. The PE starter 470 may determine whether the number counted by the down counter 460 in a clock cycle matches any of the workload scores determined by the workload module 450. In response to determining that the number counted by the down counter 460 matches a workload score, the PE starter 470 may instruct the PE to start computation in the next clock cycle. In response to determining that the number counted by the down counter 460 does not match any workload score, the PE starter 470 take no further action. After the number of the down counter 460 is changed in the next clock cycle, the PE starter 470 may determine whether the new/lower number matches any of the workload scores. The start time of the computation in a PE is dependent on the workload of the PE, i.e., the number of ones in the combined sparsity bitmap of the PE. In some embodiments, the computations in the PEs may end at the same time. As the PE having the highest workload starts computation first, the total amount of time for completing all the computations in the PEs may be equal to the amount of time for completing the computation in the PE having the highest workload, which avoids the risk of impairing the performance and efficiency of the compute block 400 or the DNN accelerator 300.

FIG. 5 illustrates a PE array 500, in accordance with various embodiments. The PE array 500 may be an embodiment of the PE array 420 in FIG. 4. The PE array 500 includes a plurality of PEs 510 (individually referred to as “PE 510”). The PEs 510 perform MAC operations. The PEs 510 may also be referred to as neurons in the DNN. Each PE 510 has two input signals 550 and 560 and an output signal 570. The input signal 550 is at least a portion of an IFM to the layer. The input signal 560 is at least a portion of a filter of the layer. In some embodiments, the input signal 550 of a PE 510 includes one or more input operands, and the input signal 560 includes one or more weight operand.

Each PE 510 performs an MAC operation on the input signals 550 and 560 and outputs the output signal 570, which is a result of the MAC operation. Some or all of the input signals 550 and 560 and the output signal 570 may be in an integer format, such as INT8, or floating-point format, such as FP16 or BF16. For purpose of simplicity and illustration, the input signals and output signal of all the PEs 510 have the same reference numbers, but the PEs 510 may receive different input signals and output different output signals from each other. Also, a PE 510 may be different from another PE 510, e.g., including more, fewer, or different components.

As shown in FIG. 5, the PEs 510 are connected to each other, as indicated by the dash arrows in FIG. 5. The output signal 570 of an PE 510 may be sent to many other PEs 510 (and possibly back to itself) as input signals via the interconnections between PEs 510. In some embodiments, the output signal 570 of an PE 510 may incorporate the output signals of one or more other PEs 510 through an accumulate operation of the PE 510 and generates an internal partial sum of the PE array. More details about the PEs 510 are described below in conjunction with FIG. 5B.

In the embodiments of FIG. 5, the PEs 510 are arranged into columns 505 (individually referred to as “column 505”). The input and weights of the layer may be distributed to the PEs 510 based on the columns 505. Each column 505 has a column buffer 520. The column buffer 520 stores data provided to the PEs 510 in the column 505 for a short amount of time. The column buffer 520 may also store data output by the last PE 510 in the column 505. The output of the last PE 510 may be a sum of the MAC operations of all the PEs 510 in the column 505, which is a column-level internal partial sum of the PE array 500. In other embodiments, input and weights may be distributed to the PEs 510 based on rows in the PE array 500. The PE array 500 may include row buffers in lieu of column buffers 520. A row buffer may store input signals of the PEs in the corresponding row and may also store a row-level internal partial sum of the PE array 500.

As shown in FIG. 5, each column buffer 520 is associated with a load 530 and a drain 540. The data provided to the column 505 is transmitted to the column buffer 520 through the load 530, e.g., through upper memory hierarchies, e.g., the local memory 410 in FIG. 4. The data generated by the column 505 is extracted from the column buffers 520 through the drain 540. In some embodiments, data extracted from a column buffer 520 is sent to upper memory hierarchies, e.g., the local memory 410 in FIG. 4, through the drain operation. In some embodiments, the drain operation does not start until all the PEs 510 in the column 505 has finished their MAC operations. In some embodiments, the load 530 or drain 540 may be controlled by the controlling module 340. Even though not shown in FIG. 5, one or more columns 505 may be associated with an external adder assembly.

FIG. 6 is a block diagram of a PE 600, in accordance with various embodiments. The PE 600 may be an embodiment of the PE 510 in FIG. 5. The PE 600 includes input register files 610 (individually referred to as “input register file 610”), weight registers file 620 (individually referred to as “weight register file 620”), multipliers 630 (individually referred to as “multiplier 630”), an internal adder assembly 640, and an output register file 650. In other embodiments, the PE 600 may include fewer, more, or different components. For example, the PE 600 may include multiple output register files 650. As another example, the PE 600 may include a single input register file 610, weight register file 620, or multiplier 630. As yet another example, the PE 600 may include an adder in lieu of the internal adder assembly 640.

The input register files 610 temporarily store input operands for MAC operations by the PE 600. In some embodiments, an input register file 610 may store a single input operand at a time. In other embodiments, an input register file 610 may store multiple input operand or a portion of an input operand at a time. An input operand includes a plurality of input elements (i.e., input elements) in an input tensor. The input elements of an input operand may be stored sequentially in the input register file 610 so the input elements can be processed sequentially. In some embodiments, each input element in the input operand may be from a different input channel of the input tensor. The input operand may include an input element from each of the input channels of the input tensor, and the number of input elements in an input operand may equal the number of the input channels. The input elements in an input operand may have the same XY coordinates, which may be used as the XY coordinates of the input operand. For instance, all the input elements of an input operand may be X0Y0, X0Y1, X1Y1, etc.

The weight register file 620 temporarily stores weight operands for MAC operations by the PE 600. The weight operands include weights in the filters of the DNN layer. In some embodiments, the weight register file 620 may store a single weight operand at a time. other embodiments, an input register file 610 may store multiple weight operands or a portion of a weight operand at a time. A weight operand may include a plurality of weights. The weights of a weight operand may be stored sequentially in the weight register file 620 so the weight can be processed sequentially. In some embodiments, for a multiplication operation that involves a weight operand and an input operand, each weight in the weight operand may correspond to an input element of the input operand. The number of weights in the weight operand may equal the number of the input elements in the input operand.

In some embodiments, a weight register file 620 may be the same or similar as an input register file 610, e.g., having the same size, etc. The PE 600 may include a plurality of register files, some of which are designated as the input register files 610 for storing input operands, some of which are designated as the weight register files 620 for storing weight operands, and some of which are designated as the output register file 650 for storing output operands. In other embodiments, register files in the PE 600 may be designated for other purposes, e.g., for storing scale operands used in elementwise add operations, etc. The designation of the register files may be controlled by the controlling module 340.

The multipliers 630 perform multiplication operations on input operands and weight operands. A multiplier 630 may perform a sequence of multiplication operations on a single input operand and a single weight operand and generates a product operand including a sequence of products. Each multiplication operation in the sequence includes multiplying an input element in the input operand and a weight in the weight operand. In some embodiments, a position (or index) of the input element in the input operand matches the position (or index) of the weight in the weight operand. For instance, the first multiplication operation is a multiplication of the first input element in the input operand and the first weight in the weight operand, the second multiplication operation is a multiplication of the second input element in the input operand and the second weight in the weight operand, the third multiplication operation is a multiplication of the third input element in the input operand and the third weight in the weight operand, and so on. The input element and weight in the same multiplication operation may correspond to the same depthwise channel, and their product may also correspond to the same depthwise channel.

Multiple multipliers 630 may perform multiplication operations simultaneously. These multiplication operations may be referred to as a round of multiplication operations. In a round of multiplication operations by the multipliers 630, each of the multipliers 630 may use a different input operand and a different weight operand. The different input operands or weight operands may be stored in different register files of the PE 600. For instance, a first multiplier 630 uses a first input operand (e.g., stored in a first input register file 610) and a first weight operand (e.g., stored in a first weight register file 620), versus a second multiplier 630 uses a second input operand (e.g., stored in a second input register file 610) and a second weight operand (e.g., stored in a second weight register file 620), a third multiplier 630 uses a third input operand (e.g., stored in a third input register file 610) and a third weight operand (e.g., stored in a third weight register file 620), and so on. For an individual multiplier 630, the round of multiplication operations may include a plurality of cycles. A cycle includes a multiplication operation on an input element and a weight.

The multipliers 630 may perform multiple rounds of multiplication operations. A multiplier 630 may use the same weight operand but different input operands in different rounds. For instance, the multiplier 630 performs a sequence of multiplication operations on a first input operand stored in a first input register file in a first round, versus a second input operand stored in a second input register file in a second round. In the second round, a different multiplier 630 may use the first input operand and a different weight operand to perform another sequence of multiplication operations. That way, the first input operand is reused in the second round. The first input operand may be further reused in additional rounds, e.g., by additional multipliers 630.

The internal adder assembly 640 includes one or more adders inside the PE 600, i.e., internal adders. The internal adder assembly 640 may perform accumulation operations on two or more products operands from multipliers 630 and produce an output operand of the PE 600. In some embodiments, the internal adders are arranged in a sequence of tiers. A tier includes one or more internal adders. For the first tier of the internal adder assembly 640, an internal adder may receive product operands from two or more multipliers 630 and generate a sum operand through a sequence of accumulation operations. Each accumulation operation produces a sum of two or more products, each of which is from a different multiplier 630. The sum operand includes a sequence of sums, each of which is a result of an accumulation operation and corresponds to a depthwise channel. For the other tier(s) of the internal adder assembly 640, an internal adder in a tier receives sum operands from the precedent tier in the sequence. Each of these number may be generated by a different internal adder in the precedent tier. A ratio of the number of internal adders in a tier to the number of internal adders in a subsequent tier may be 2:1. In some embodiments, the last tier of the internal adder assembly 640 may include a single internal adder, which produces the output operand of the PE 600.

The output register file 650 stores output operands of the PE 600. In some embodiments, the output register file 650 may store an output operand at a time. In other embodiments, the output register file 650 may store multiple output operand or a portion of an output operand at a time. An output operand includes a plurality of output elements in an IFM. The output elements of an output operand may be stored sequentially in the output register file 650 so the output elements can be processed sequentially. In some embodiments, each output element in the output operand corresponds to a different depthwise channel and is an element of a different output channel of the output channel of the depthwise convolution. The number of output element in an output operand may equal the number of the depthwise channels of the depthwise convolution.

### Example Sparsity Acceleration in PE

FIG. 7 illustrates sparsity acceleration in an MAC operation by a PE 700, in accordance with various embodiments. The PE 700 may be an example of the PE 510 in FIG. 5. In the embodiments of FIG. 7, the PE 700 includes an input register file 710, a weight register file 720, a multiplier 730, an accumulator 740, and an output register file 750. In other embodiments, the PE 700 may include fewer, more, or different components. The PE 700 is associated with a logical operator 760 and a sparsity logic unit 770. The logical operator 760 and sparsity logic unit 770 may be components of an embodiment of the sparsity accelerator 430 in FIG. 4.

The input register file 710 stores at least part of an input operand. The input operand includes a sequence of input elements, aka activations. The input operand may be a portion of an input tensor, e.g., an input tensor of a convolutional layer. The input operand is associated with an input bitmap 715. The input bitmap 715 may be stored in the input register file 710, the local memory of the compute block that includes the PE 700, or both. The input bitmap 715 can indicate positions of the nonzero-valued activations in the input operand. The input bitmap 715 includes a sequence of bits, each of which corresponds to a respective activation in the input operand. In some embodiments, the position of a bit in the input bitmap 715 matches the position of the corresponding activation in the input operand. For the purpose of illustration, the input bitmap 715 includes eight bits, and the input operand includes eight activations. In other embodiments, the input bitmap 715 may include fewer or more bits. As shown in FIG. 7, four of the eight bits in the input bitmap 715 are zero-valued, and the other four bits are one valued. A zero-valued bit indicates that the value of the corresponding activation is zero, a one valued bit indicates that the value of the corresponding activation is non-zero. Accordingly, the input operand includes four zero-valued activations and four nonzero-valued activations.

The weight register file 720 stores at least part of a weight operand. The weight operand includes a sequence of weights. The weight operand may be a portion of a filter, e.g., a filter of a convolutional layer. The weight operand is associated with a weight bitmap 725. The weight bitmap 725 may be stored in the weight register file 720, the local memory of the compute block that includes the PE 700, or both. The weight bitmap 725 can indicate positions of the nonzero-valued weights in the weight operand. The weight bitmap 725 includes a sequence of bits, each of which corresponds to a respective weight in the weight operand. In some embodiments, the position of a bit in the weight bitmap 725 matches the position of the corresponding weight in the weight operand. For the purpose of illustration, the weight bitmap 725 includes eight bits, and the weight operand includes eight weights. In other embodiments, the weight bitmap 725 may include fewer or more bits. As shown in FIG. 7, four of the eight bits in the weight bitmap 725 are zero-valued, and the other four bits are one valued. A zero-valued bit indicates that the value of the corresponding weight is zero, a one valued bit indicates that the value of the corresponding weight is non-zero. Accordingly, the weight operand includes four zero-valued weights and four nonzero-valued weights. The weight bitmap 725 can indicate positions of the nonzero-valued weights in the weight operand.

The logical operator 760 generates a combined sparsity bitmap 735 based on the input bitmap 715 and the weight bitmap 725. The logical operator 760 may receive the input bitmap 715 from the input register file 710 or the local memory of the compute block that includes the PE 700. The logical operator 760 may receive the weight bitmap 725 from the weight register file 720 or the local memory of the compute block. In some embodiments, the logical operator 760 is an AND operator. The logical operator 760 may generate the combined sparsity bitmap 735 by performing one or more AND operations on the input bitmap 715 and the weight bitmap 725. Each bit in the combined sparsity bitmap 735 is a result of an AND operation on a bit in the input bitmap 715 and a bit in the weight bitmap 725. A position of the bit in the combined sparsity bitmap 735 matches the position of the bit in the input bitmap 715 and the position of the bit in the weight bitmap 725. For instance, the first bit in the combined sparsity bitmap 735 is a result of an AND operation on the first bit in the input bitmap 715 and the first bit in the weight bitmap 725, the second bit in the combined sparsity bitmap 735 is a result of an AND operation on the second bit in the input bitmap 715 and the second bit in the weight bitmap 725, the third bit in the combined sparsity bitmap 735 is a result of an AND operation on the third bit in the input bitmap 715 and the third bit in the weight bitmap 725, and so on.

A bit in the combined sparsity bitmap 735 has a value of one when the corresponding bit in the input bitmap 715 and the corresponding bit in the weight bitmap 725 both have values of one. When at least one of the corresponding bits in the input bitmap 715 and the corresponding bit in the weight bitmap 725 has a value of zero, the bit in the combined sparsity bitmap 735 has a value of zero. As shown in FIG. 7, the combined sparsity bitmap 735 includes six zeros and two ones.

The total number of ones in the combined sparsity bitmap 735 equals the total number of activation-weight pairs that will result in nonzero-valued partial sums and will be computed by the PE 700. The other activation-weight pairs can be skipped for computation without any impact on the output accuracy, as these pairs will result in zero-valued partial sums since the activation or weight is zero. Accordingly, the workload of the PE 700 in this compute round can be determined based on the total number of ones in the combined sparsity bitmap 735. The amount of time for the computation can also be estimated based on the total number of ones in the combined sparsity bitmap 735. The more ones in the combined sparsity bitmap 735, the higher the workload of the PE 700, and the longer the computation of the PE 700.

The sparsity logic unit 770 retrieves activations and weights from the input register file 710 and the weight register file 720, respectively, based on the combined sparsity bitmaps 735. To accelerate the computation in the PE 700, the sparsity logic unit 770 retrieves the two activation-weight pairs that correspond to the ones in the combined sparsity bitmaps 735 and does not retrieve the six activation-weight pairs that correspond to the zeros in the combined sparsity bitmaps 735. In some embodiments, the input register file 710 or the weight register file 720 stores dense data points, e.g., nonzero-valued activations or nonzero-valued weights. The sparse data points, e.g., zero-valued activations or zero-valued weights, are not stored in the input register file 710 or the weight register file 720. The dense data points may be compressed and kept adjacent to each other in the input register file 710 or the weight register file 720. The sparsity logic unit 770 may identify the activations and weights based on the positions of the ones in the combined sparsity bitmaps 735, which can indicate the positions of the non-zero activations in the input operand and the positions of the non-zero weights in the weight operand.

The multiplier 730 receives the non-zero activation-weight pairs from the sparsity logic unit 770 and performs multiplication operations on the activation-weight pairs. For instance, the multiplier 730 performs a multiplication operation on the activation and weight in an individual pair and outputs a partial sum, i.e., a product of the activation and weight. As there are two activation-weight pairs, the multiplier 730 may perform two multiplication operations sequentially, e.g., based on the positions of the ones in the combined sparsity bitmaps 735. Without the sparsity acceleration, the multiplier 730 would need to perform eight multiplication operations. By reducing the number of multiplication operations from eight to two, the MAC operation in the PE 700 is accelerated. As a DNN accelerator usually performs a large number of MAC operations in the execution of a DNN, the sparsity acceleration can significantly improve the efficiency and performance of the DNN accelerator.

The accumulator 740 receives the two partial sums from the multiplier 730 and accumulates the two partial sums. The result of the accumulation is a PE-level internal partial sum. The PE-level internal partial sum may be stored in the output register file 750. In some embodiments, the accumulator 740 receives one or more PE-level internal partial sums from one or more other PEs. The accumulator 740 can accumulate the one or more PE-level internal partial sums with the PE-level internal partial sum of the PE 700 and store the result of the accumulation (i.e., a multi-PE internal partial sum) in the output register file 750. The one or more other PEs may be in the same column as the PE 700 in a PE array. The multi-PE internal partial sum may be a column-level internal partial sum. In some embodiments, the PE-level internal partial sum of the PE 700 or the multi-PE internal partial sum may be sent to one or more other PEs for further accumulation.

Even though FIG. 7 shows a single multiplier 730, the PE 700 may include multiple multipliers that can perform multiple multiplication operations at the same time. These multipliers can be coupled to an internal adder assembly, e.g., the internal adder assembly 640. The combined sparsity bitmap 735 can be also provided to a compute scheduler (e.g., the computation scheduler 440) to schedule the start of the MAC operation in the PE 700 to reduce voltage droops in a group of PEs that include the PE 700.

### Example Computation Schedule

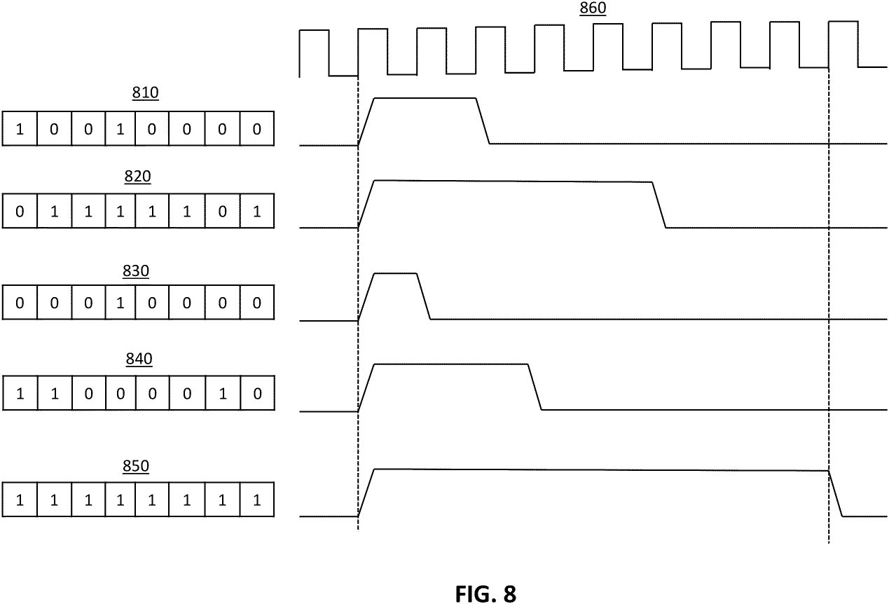

FIG. 8 illustrates a computation schedule for a group of PEs, in which computations by the PEs start at the same time, in accordance with various embodiments. For the purpose of illustration, there are five PEs in the group. In other embodiments, the group may include a different number of PEs. The PEs in the group may be arranged in a single column of a PE array, in multiple columns of a PE array, and so on. FIG. 8 shows combined sparsity bitmaps 810, 820, 830, 840, and 850 for the five PEs.

The PEs are associated with one or more sparsity accelerators (e.g., the sparsity accelerator 430) which can accelerate the computations in the PEs based on the combined sparsity bitmaps 810, 820, 830, 840, and 850. The number of ones in each of the combined sparsity bitmaps 810, 820, 830, 840, and 850 indicates the amount of computation that the corresponding PE will perform. Accordingly, the PE having the combined sparsity bitmap 850 has the highest workload, followed by the PE having the combined sparsity bitmap 820, then the PE having the combined sparsity bitmap 840 and the PE having the combined sparsity bitmap 810. The PE having the combined sparsity bitmap 830 has the lowest workload.

FIG. 8 also shows a clock cycle sequence 860. The clock cycle sequence 860 may be generated by a clock generator associated with the group of PEs, e.g., a clock generator of the DNN accelerator including the group of PEs. The clock cycle sequence 860 may be used to synchronize the operations of the PEs. In the embodiments of FIG. 8, the computations of the PEs are not scheduled based on the combined sparsity bitmaps 810, 820, 830, 840, and 850. Rather, the starts of the computations are synchronized and are all in the second clock cycle of the clock cycle sequence 860. The synchronized starts of the computations can cause a large current transient and therefore, result in a large voltage droop, which can degrade the DNN accelerator or even cause functional failures.

As the workloads of the PEs are different, the computation in the PEs takes different numbers of clock cycles and therefore, end in different clock cycles, as shown in FIG. 8. The computation in the PE having the combined sparsity bitmap 850 ends last. Thus, the total amount of time for completing the computations in the group of PEs is eight clock cycles.

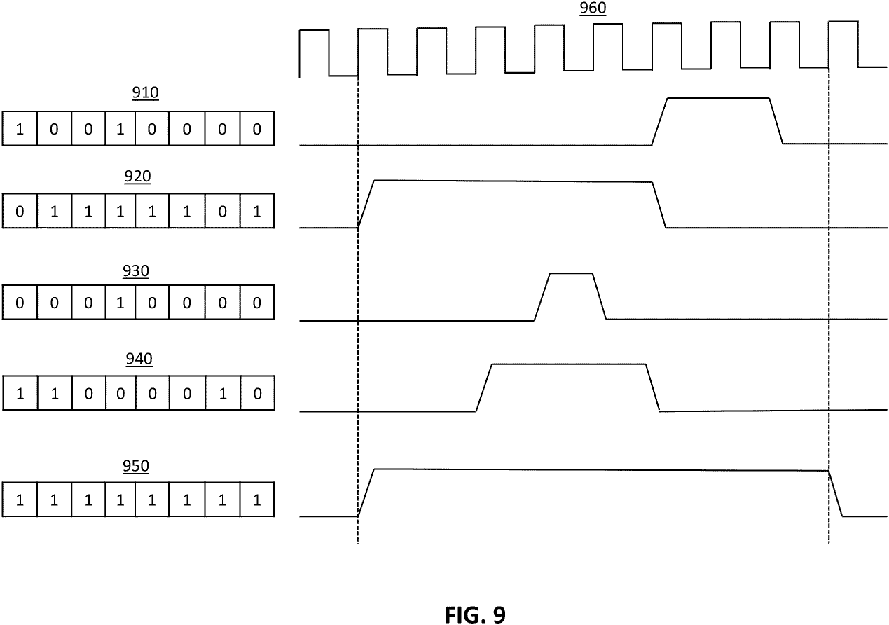

FIG. 9 illustrates a computation schedule for a group of PEs that can reduce voltage droop, in accordance with various embodiments. For the purpose of illustration, there are five PEs in the group. In other embodiments, the group may include a different number of PEs. The PEs in the group may be arranged in a single column of a PE array, in multiple columns of a PE array, and so on. FIG. 9 shows combined sparsity bitmaps 910, 920, 930, 940, and 950 for the five PEs.

The PEs are associated with one or more sparsity accelerators (e.g., the sparsity accelerator 430) which can accelerate the computations in the PEs based on the combined sparsity bitmaps 910, 920, 930, 940, and 950. The number of ones in each of the combined sparsity bitmaps 910, 920, 930, 940, and 950 indicates the amount of computation that the corresponding PE will perform. Accordingly, the PE having the combined sparsity bitmap 950 has the highest workload, followed by the PE having the combined sparsity bitmap 920, then the PE having the combined sparsity bitmap 940 and the PE having the combined sparsity bitmap 910. The PE having the combined sparsity bitmap 930 has the lowest workload.

FIG. 9 also shows a clock cycle sequence 960. The clock cycle sequence 960 may be generated by a clock generator associated with the group of PEs, e.g., a clock generator of the DNN accelerator including the group of PEs. In the embodiments of FIG. 9, the computations of the PEs are scheduled based on the combined sparsity bitmaps 910, 920, 930, 940, and 950. The computation schedule is determined by a computation scheduler, such as the computation scheduler 440. The computations in the PE having the combined sparsity bitmap 950 and the PE having the combined sparsity bitmap 920 are started first in the second clock cycle. The computations in the other PEs are started in later clock cycles. Compared with the computation schedule in FIG. 8, the computation schedule in FIG. 9 can reduce the current transient and voltage droop as less PEs start their computations at the same time.

As shown in FIG. 9, the computations in the PEs end in different clock cycles. Compared with the computation schedule in FIG. 8, the computation schedule in FIG. 9 does not cause any delay in the completion of the computations in the group of PEs as the computation in the PE having the combined sparsity bitmap 950 still ends last and the total amount of time for completing the computations in the group of PEs is eight clock cycles.

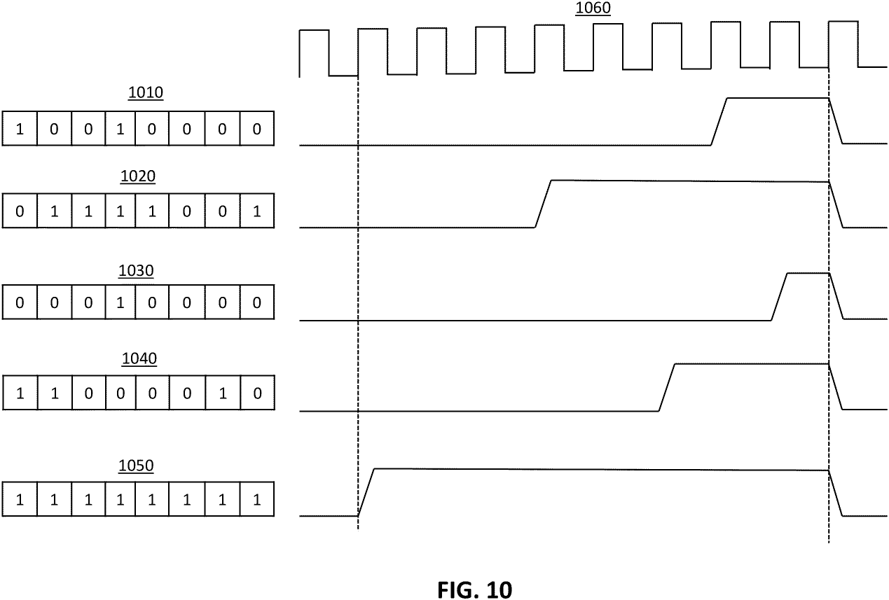

FIG. 10 illustrates another computation schedule for a group of PEs that can reduce voltage droop, in accordance with various embodiments. For the purpose of illustration, there are five PEs in the group. In other embodiments, the group may include a different number of PEs. The PEs in the group may be arranged in a single column of a PE array, in multiple columns of a PE array, and so on. FIG. 10 shows combined sparsity bitmaps 1010, 1020, 1030, 1040, and 1050 for the five PEs.

The PEs are associated with one or more sparsity accelerators (e.g., the sparsity accelerator 430) which can accelerate the computations in the PEs based on the combined sparsity bitmaps 1010, 1020, 1030, 1040, and 1050. The number of ones in each of the combined sparsity bitmaps 1010, 1020, 1030, 1040, and 1050 indicates the amount of computation that the corresponding PE will perform. Accordingly, the PE having the combined sparsity bitmap 1050 has the highest workload, followed by the PE having the combined sparsity bitmap 1020, then the PE having the combined sparsity bitmap 1040 and the PE having the combined sparsity bitmap 1010. The PE having the combined sparsity bitmap 1030 has the lowest workload.

FIG. 10 also shows a clock cycle sequence 1060. The clock cycle sequence 1060 may be generated by a clock generator associated with the group of PEs, e.g., a clock generator of the DNN accelerator including the group of PEs. In the embodiments of FIG. 10, the computations of the PEs are scheduled based on the combined sparsity bitmaps 1010, 1020, 1030, 1040, and 1050. The PEs start their computations at different times. The higher the workload of the PE, the earlier the computation in the PE starts.

In some embodiments, the computation schedule is determined by a computation scheduler that uses a down counter to schedule PE computations. The down counter may count down from eight (i.e., the number of ones in the combined sparsity bitmap 1050) towards one (i.e., the number of ones in the combined sparsity bitmap 1030) or towards zero. For instance, the down counter has eight in the first clock cycle of the clock cycle sequence 1060, has seven in the second clock cycle, has six in the third clock cycle, and so on. The counting down continues till the eighth clock cycle (when the down counter has one) or the ninth clock cycle (when the down counter has zero). The computation of a PE will be started in the clock cycle right after the clock cycle in which the number of the down counter matches the numbers of ones in the combined sparsity bitmap of the PE. As shown in FIG. 10, the computation in the PE having the combined sparsity bitmap 1050 is started first in the second clock cycle as the number of the down counter matches the number of ones in the combined sparsity bitmap 1050 in the first clock cycle. Similarly, the computation in the PE having the combined sparsity bitmap 1020 is started in the fifth clock cycle as the number of the down counter matches the number of ones in the combined sparsity bitmap 1020 in the fourth clock cycle. The computation in the PE having the combined sparsity bitmap 1040 is started in the seventh clock cycle. The computation in the PE having the combined sparsity bitmap 1010 is started in the eighth clock cycle. The computation in the PE having the combined sparsity bitmap 1030 is started in the eighth clock cycle.

Compared with the computation schedules in FIGS. 8 and 9, the computation schedule in FIG. 10 can further reduce the current transient and voltage droop as none of the PEs start their computations at the same time. As shown in FIG. 10, the computations in the PEs end at the same time and therefore, does not cause any delay in the completion of all the computations in the group of PEs.

### Example Method of Scheduling Computations in DNN

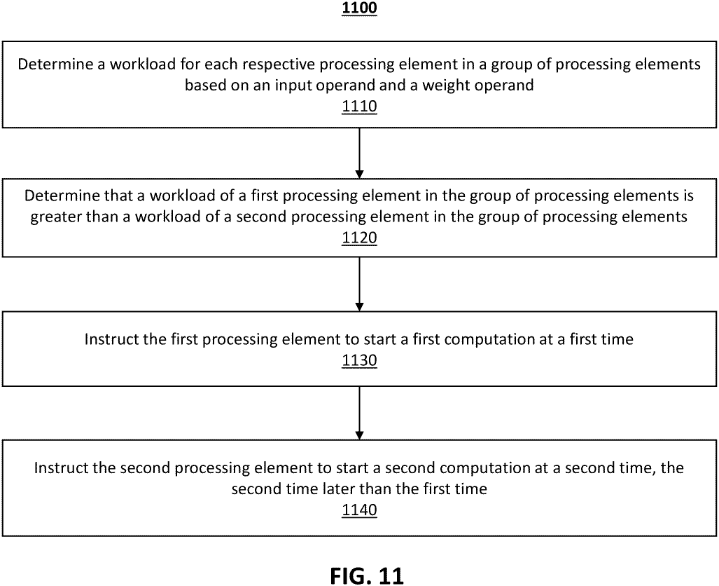

FIG. 11 is a flowchart showing a method 1100 of scheduling computations in a DNN, in accordance with various embodiments. The method 1100 may be performed by the computation scheduler 440 in FIG. 4. Although the method 1100 is described with reference to the flowchart illustrated in FIG. 11, many other methods for scheduling computations in a DNN may alternatively be used. For example, the order of execution of the steps in FIG. 11 may be changed. As another example, some of the steps may be changed, eliminated, or combined.

The computation scheduler 440 determines 1110 a workload for each respective PE in a group of PEs based on an input operand and a weight operand. The respective PE is configured to perform a computation (e.g., a MAC operation) on the input operand and weight operand. The input operand comprises a plurality of activations of a convolution. The weight operand comprises a plurality of weights of the convolution. In some embodiments, the group of PEs is at least part of an array of PEs. The array of PEs is configured to perform at least part of the convolution. The array of PEs comprises rows and columns. The group of PEs is arranged in one of the columns.

In some embodiments, the computation scheduler 440 determines the workload of the respective PE based on an input sparsity bitmap and a weight sparsity bitmap. The input sparsity bitmap comprises a sequence of bits, each of which indicates whether a value of a respective activation in the input operand is zero. The weight sparsity bitmap comprises another sequence of bits, each of which indicates whether a value of a respective weight in the weight operand is zero. A combined sparsity bitmap may be generated based on the input sparsity bitmap and the weight sparsity bitmap. The combined sparsity bitmap comprises a plurality of bits, each of which is a result of a bit in the input sparsity bitmap multiplying a bit in the weight sparsity bitmap. The computation scheduler 440 may determine the workload based on the number of ones in the combined sparsity bitmap.

The computation scheduler 440 determines 1120 that a workload of a first PE in the group of PEs is greater than a workload of a second PE in the group of PEs. For example, the computation scheduler 440 determines that the number of ones in a combined sparsity bitmap associated with the first PE is greater than the number of ones in a combined sparsity bitmap associated with the second PE.

The computation scheduler 440 instructs 1130 the first PE to start a first computation at a first time. In some embodiments, the computation scheduler 440 determines that the workload of the first PE is greater than one or more workloads of one or more other PEs in the group of PEs. The computation scheduler 440 instructs the first PE to start the first computation in a first clock cycle in a sequence of clock cycles. One or more computations of the one or more other PEs start in one or more clock cycles that are subsequent to the first clock cycle in the sequence of clock cycles.

The computation scheduler 440 instructs 1140 the second PE to start a second computation at a second time, the second time later than the first time. In some embodiments, the computation scheduler 440 associates a sequence of numbers with a sequence of clock cycles. Each respective clock cycle is associated with a greater number than another clock cycle subsequent to the respective clock cycle in the sequence of clock. The first clock cycle, in which the first computation starts, is associated with a first number representing the workload of the first PE. The computation scheduler 440 determines a second number representing the workload of the second PE. The computation scheduler 440 identifies, from the sequence of clock cycles, a second clock cycle associated with the second number. The computation scheduler 440 instructs the second PE to start the second computation in the second clock cycle.

In some embodiments, the computation scheduler 440 determines the first time and the second time based on the workload of the first PE and the workload of the second PE. The first computation and the second computation end at the same time. In some embodiments, the computation scheduler 440 determines the second time based on the workload of the first PE and the workload of the second PE. The second computation ends no later than the first computation.

### Example Computing Device

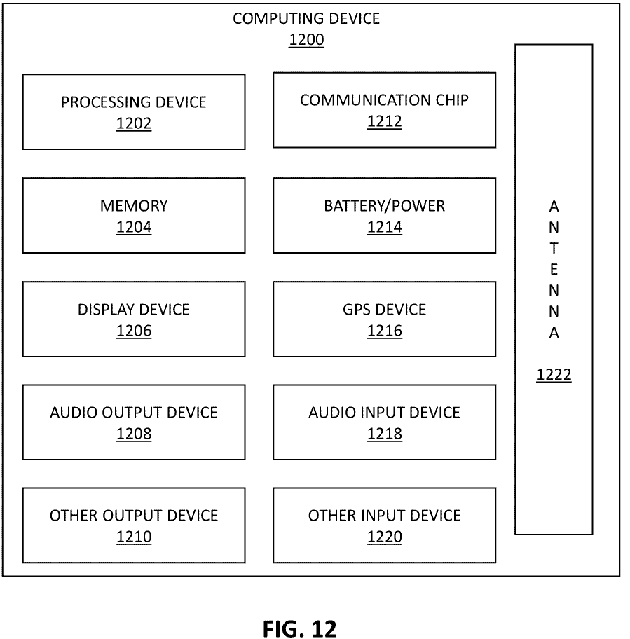

FIG. 12 is a block diagram of an example computing device 1200, in accordance with various embodiments. In some embodiments, the computing device 1200 may be used as at least part of the DNN accelerator 300 in FIG. 3. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208, but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform operations for scheduling computations in DNNs, e.g., the method 1100 described above in conjunction with FIG. 11 or some operations performed by the computation scheduler 440 described above in conjunction with FIG. 4. The instructions stored in the one or more non-transitory computer-readable media may be executed by the processing device 1202.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include another output device 1210 (or corresponding interface circuitry, as discussed above). Examples of the other output device 1210 may include an audio codec, a video codec, a printer, a wired or wireless transmitter for providing information to other devices, or an additional storage device.

The computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1200 may have any desired form factor, such as a handheld or mobile computer system (e.g., a cell phone, a smart phone, a mobile internet device, a music player, a tablet computer, a laptop computer, a netbook computer, an ultrabook computer, a PDA (personal digital assistant), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

### Select Examples

The following paragraphs provide various examples of the embodiments disclosed herein.

Example 1 provides a method of scheduling computations in a DNN, including determining a workload for each respective PE in a group of PEs based on an input operand and a weight operand, the respective PE configured to perform a computation on the input operand and weight operand, the input operand including a plurality of activations of a convolution, the weight operand including a plurality of weights of the convolution; determining that a workload of a first PE in the group of PEs is greater than a workload of a second PE in the group of PEs; instructing the first PE to start a first computation at a first time; and instructing the second PE to start a second computation at a second time, the second time later than the first time.

Example 2 provides the method of example 1, where determining the workload of the respective PE based on the input operand and the weight operand includes determining the workload of the respective PE based on an input sparsity bitmap and a weight sparsity bitmap, where the input sparsity bitmap includes a sequence of bits, each of which indicates whether a value of a respective activation in the input operand is zero, and the weight sparsity bitmap includes another sequence of bits, each of which indicates whether a value of a respective weight in the weight operand is zero.

Example 3 provides the method of example 2, where determining the workload based on the input sparsity bitmap and the weight sparsity bitmap includes generating a combined sparsity bitmap based on the input sparsity bitmap and the weight sparsity bitmap, the combined sparsity bitmap including a plurality of bits, each of which is a result of a bit in the input sparsity bitmap multiplying a bit in the weight sparsity bitmap; and determining the workload based on a number of ones in the combined sparsity bitmap.

Example 4 provides the method of any of the preceding examples, where determining that the workload of the first PE in the group of PEs is greater than the workload of the second PE in the group of PEs includes determining that a number of ones in a combined sparsity bitmap associated with the first PE is greater than a number of ones in a combined sparsity bitmap associated with the second PE.

Example 5 provides the method of any of the preceding examples, further including determining the first time and the second time based on the workload of the first PE and the workload of the second PE, where the second computation ends no later than the first computation.

Example 6 provides the method of any of the preceding examples, further including determining the second time based on the workload of the first PE and the workload of the second PE, where the second computation ends no later than the first computation.

Example 7 provides the method of any of the preceding examples, where instructing the first PE to start the first computation at the first time includes determining that the workload of the first processing element is greater than at least one workload of another processing element in the group of processing elements; and instructing the first processing element to start the first computation in a first clock cycle in a sequence of clock cycles, where the other processing element having less workload than the first processing element start in one or more clock cycles that are subsequent to the first clock cycle in the sequence of clock cycles.

Example 8 provides the method of any of the preceding examples, where instructing the second PE to start the second computation at the second time includes associating a sequence of numbers with the sequence of clock cycles, each respective clock cycle associated with a greater number than another clock cycle subsequent to the respective clock cycle in the sequence of clock cycles, the first clock cycle associated with a first number representing the workload of the first PE; determining a second number representing the workload of the second PE; identifying, from the sequence of clock cycles, a second clock cycle associated with the second number; and instructing the second PE to start the second computation in the second clock cycle.

Example 9 provides the method of any of the preceding examples, where the group of PEs is at least part of an array of PEs, the array of PEs configured to perform at least part of the convolution.

Example 10 provides the method of example 9, where the group of processing elements is at least part of an array of processing elements, wherein the array of processing elements is configured to perform at least part of the convolution, and wherein the array of processing elements comprises rows and columns, and the group of processing elements is arranged in one of the columns.

Example 11 provides a compute block for executing computation in a DNN, the compute block including a group of PEs, each PE configured to perform a computation on an input operand and weight operand, where the input operand includes a plurality of activations of a convolution, and the weight operand includes a plurality of weights of the convolution; and a computation scheduler configured to determining a workload of each PE based on the input operand and the weight operand, determine that a workload of a first PE in the group of PEs is greater than a workload of a second PE in the group of PEs, instruct the first PE to start a first computation at a first time, and instruct the second PE to start a second computation at a second time, the second time later than the first time.

Example 12 provides the compute block of example 11, where the computation scheduler is configured to determine the workload of the respective PE based on the input operand and the weight operand by determining the workload of the respective PE based on an input sparsity bitmap and a weight sparsity bitmap, where the input sparsity bitmap includes a sequence of bits, each of which indicates whether a value of a respective activation in the input operand is zero, and the weight sparsity bitmap includes another sequence of bits, each of which indicates whether a value of a respective weight in the weight operand is zero.

Example 13 provides the compute block of example 12, further including a sparsity accelerator configured to generate a combined sparsity bitmap based on the input sparsity bitmap and the weight sparsity bitmap, the combined sparsity bitmap including a plurality of bits, each of which is a result of a bit in the input sparsity bitmap multiplying a bit in the weight sparsity bitmap, where the computation scheduler is configured to determine the workload based on a number of ones in the combined sparsity bitmap.

Example 14 provides the compute block of any one of examples 11-13, where the computation scheduler is configured to determine that the workload of the first PE in the group of PEs is greater than the workload of the second PE in the group of PEs by determining that a number of ones in a combined sparsity bitmap associated with the first PE is greater than a number of ones in a combined sparsity bitmap associated with the second PE.

Example 15 provides the compute block of any one of examples 11-14, where the computation scheduler is further configured to determine the first time and the second time based on the workload of the first PE and the workload of the second PE, where the first computation and the second computation end at a same time.

Example 16 provides the compute block of any one of examples 11-15, where the computation scheduler is further configured to determine the second time based on the workload of the first PE and the workload of the second PE, where the second computation ends no later than the first computation.

Example 17 provides the compute block of any one of examples 11-16, where the computation scheduler is configured to instruct the first PE to start the first computation at the first time by determining that the workload of the first PE is greater than one or more workloads of one or more other PEs in the group of PEs; and instructing the first PE to start the first computation in a first clock cycle in a sequence of clock cycles, where one or more computations of the one or more other PEs start in one or more clock cycles that are subsequent to the first clock cycle in the sequence of clock cycles.

Example 18 provides the compute block of any one of examples 11-17, where the computation scheduler is configured to instruct the second PE to start the second computation at the second time by associating a sequence of numbers with the sequence of clock cycles, each respective clock cycle associated with a greater number than another clock cycle subsequent to the respective clock cycle in the sequence of clock cycles, the first clock cycle associated with a first number representing the workload of the first PE; determining a second number representing the workload of the second PE; identifying, from the sequence of clock cycles, a second clock cycle associated with the second number; and instructing the second PE to start the second computation in the second clock cycle.

Example 19 provides the compute block of any one of examples 11-18, where the group of PEs is at least part of an array of PEs, the array of PEs configured to perform at least part of the convolution.

Example 20 provides the compute block of example 19, where the array of PEs includes rows and columns, and the group of PEs is arranged in one of the columns.

Example 21 provides one or more non-transitory computer-readable media storing instructions executable to perform operations for scheduling computation in a DNN, the operations including determining a workload for each respective PE in a group of PEs based on an input operand and a weight operand, the respective PE configured to perform a computation on the input operand and weight operand, the input operand including one or more activations of a convolution, the weight operand including one or more weights of the convolution; determining that a workload of a first PE in the group of PEs is greater than a workload of a second PE in the group of PEs; instructing the first PE to start a first computation at a first time; and instructing the second PE to start a second computation at a second time, the second time later than the first time.

Example 22 provides the one or more non-transitory computer-readable media of example 21, where determining the workload of the respective PE based on the input operand and the weight operand includes determining the workload of the respective PE based on an input sparsity bitmap and a weight sparsity bitmap, where the input sparsity bitmap includes a sequence of bits, each of which indicates whether a value of a respective activation in the input operand is zero, and the weight sparsity bitmap includes another sequence of bits, each of which indicates whether a value of a respective weight in the weight operand is zero.

Example 23 provides the one or more non-transitory computer-readable media of example 22, where determining the workload based on the input sparsity bitmap and the weight sparsity bitmap includes generating a combined sparsity bitmap based on the input sparsity bitmap and the weight sparsity bitmap, the combined sparsity bitmap including a plurality of bits, each of which is a result of a bit in the input sparsity bitmap multiplying a bit in the weight sparsity bitmap; and determining the workload based on a number of ones in the combined sparsity bitmap.

Example 24 provides the one or more non-transitory computer-readable media of any one of examples 21-23, where determining the second time based on the workload of the first PE and the workload of the second PE, where the second computation ends no later than the first computation.

Example 25 provides the one or more non-transitory computer-readable media of any one of examples 21-24, where instructing the first PE to start the first computation at the first time includes determining that the workload of the first PE is greater than one or more workloads of one or more other PEs in the group of PEs; and instructing the first PE to start the first computation in a first clock cycle in a sequence of clock cycles, where one or more computations of the one or more other PEs start in one or more clock cycles that are subsequent to the first clock cycle in the sequence of clock cycles.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method of scheduling computations in a deep neural network (DNN), comprising:
determining a workload for each respective processing element in a group of processing elements based on an input operand and a weight operand, the respective processing element configured to perform a computation on the input operand and weight operand, the input operand comprising one or more activations of a convolution, the weight operand comprising one or more weights of the convolution;
determining that a workload of a first processing element in the group of processing elements is greater than a workload of a second processing element in the group of processing elements;
instructing the first processing element to start a first computation at a first time; and
instructing the second processing element to start a second computation at a second time, the second time later than the first time.

2. The method of claim 1, wherein determining the workload of the respective processing element based on the input operand and the weight operand comprises:
determining the workload of the respective processing element based on an input sparsity bitmap and a weight sparsity bitmap,
wherein the input sparsity bitmap comprises a sequence of bits, each of which indicates whether a value of a respective activation in the input operand is zero, and the weight sparsity bitmap comprises another sequence of bits, each of which indicates whether a value of a respective weight in the weight operand is zero.

3. The method of claim 2, wherein determining the workload based on the input sparsity bitmap and the weight sparsity bitmap comprises:
generating a combined sparsity bitmap based on the input sparsity bitmap and the weight sparsity bitmap, the combined sparsity bitmap comprising a plurality of bits, each of which is a result of a bit in the input sparsity bitmap multiplying a bit in the weight sparsity bitmap; and
determining the workload based on a number of ones in the combined sparsity bitmap.

4. The method of claim 1, wherein determining that the workload of the first processing element in the group of processing elements is greater than the workload of the second processing element in the group of processing elements comprises:
determining that a number of ones in a combined sparsity bitmap associated with the first processing element is greater than a number of ones in a combined sparsity bitmap associated with the second processing element.

5. The method of claim 1, further comprising:
determining the first time and the second time based on the workload of the first processing element and the workload of the second processing element,
wherein the second computation ends no later than the first computation.

6. The method of claim 1, wherein instructing the first processing element to start the first computation at the first time comprises:
determining that the workload of the first processing element is greater than at least one workload of another processing element in the group of processing elements; and
instructing the first processing element to start the first computation in a first clock cycle in a sequence of clock cycles,
wherein the other processing element having less workload than the first processing element start in one or more clock cycles that are subsequent to the first clock cycle in the sequence of clock cycles.

7. The method of claim 1, wherein instructing the second processing element to start the second computation at the second time comprises:
associating a sequence of numbers with the sequence of clock cycles, each respective clock cycle associated with a greater number than another clock cycle subsequent to the respective clock cycle in the sequence of clock cycles, the first clock cycle associated with a first number representing the workload of the first processing element;
determining a second number representing the workload of the second processing element;
identifying, from the sequence of clock cycles, a second clock cycle associated with the second number; and
instructing the second processing element to start the second computation in the second clock cycle.

8. The method of claim 1, wherein the group of processing elements is at least part of an array of processing elements, wherein the array of processing elements is configured to perform at least part of the convolution, and wherein the array of processing elements comprises rows and columns, and the group of processing elements is arranged in one of the columns.

9. One or more non-transitory computer-readable media storing instructions executable to perform operations for in-network computing, the operations comprising:
determining a workload for each respective processing element in a group of processing elements based on an input operand and a weight operand, the respective processing element configured to perform a computation on the input operand and weight operand, the input operand comprising one or more activations of a convolution, the weight operand comprising one or more weights of the convolution;
determining that a workload of a first processing element in the group of processing elements is greater than a workload of a second processing element in the group of processing elements;
instructing the first processing element to start a first computation at a first time; and
instructing the second processing element to start a second computation at a second time, the second time later than the first time.

10. The one or more non-transitory computer-readable media of claim 9, wherein determining the workload of the respective processing element based on the input operand and the weight operand comprises:
determining the workload of the respective processing element based on an input sparsity bitmap and a weight sparsity bitmap,
wherein the input sparsity bitmap comprises a sequence of bits, each of which indicates whether a value of a respective activation in the input operand is zero, and the weight sparsity bitmap comprises another sequence of bits, each of which indicates whether a value of a respective weight in the weight operand is zero.

11. The one or more non-transitory computer-readable media of claim 10, wherein determining the workload based on the input sparsity bitmap and the weight sparsity bitmap comprises:
generating a combined sparsity bitmap based on the input sparsity bitmap and the weight sparsity bitmap, the combined sparsity bitmap comprising a plurality of bits, each of which is a result of a bit in the input sparsity bitmap multiplying a bit in the weight sparsity bitmap; and
determining the workload based on a number of ones in the combined sparsity bitmap.

12. The one or more non-transitory computer-readable media of claim 9, wherein determining that the workload of the first processing element in the group of processing elements is greater than the workload of the second processing element in the group of processing elements comprises:
determining that a number of ones in a combined sparsity bitmap associated with the first processing element is greater than a number of ones in a combined sparsity bitmap associated with the second processing element.

13. The one or more non-transitory computer-readable media of claim 9, further comprising:
determining the first time and the second time based on the workload of the first processing element and the workload of the second processing element,
wherein the second computation ends no later than the first computation.

14. The one or more non-transitory computer-readable media of claim 9, wherein instructing the first processing element to start the first computation at the first time comprises:
determining that the workload of the first processing element is greater than at least one workload of another processing element in the group of processing elements; and
instructing the first processing element to start the first computation in a first clock cycle in a sequence of clock cycles,
wherein the other processing element having less workload than the first processing element start in one or more clock cycles that are subsequent to the first clock cycle in the sequence of clock cycles.

15. The one or more non-transitory computer-readable media of claim 9, wherein instructing the second processing element to start the second computation at the second time comprises:
associating a sequence of numbers with the sequence of clock cycles, each respective clock cycle associated with a greater number than another clock cycle subsequent to the respective clock cycle in the sequence of clock cycles, the first clock cycle associated with a first number representing the workload of the first processing element;
determining a second number representing the workload of the second processing element;
identifying, from the sequence of clock cycles, a second clock cycle associated with the second number; and
instructing the second processing element to start the second computation in the second clock cycle.

16. The one or more non-transitory computer-readable media of claim 9, wherein the group of processing elements is at least part of an array of processing elements, wherein the array of processing elements is configured to perform at least part of the convolution, and wherein the array of processing elements comprises rows and columns, and the group of processing elements is arranged in one of the columns.

17. An apparatus, comprising:
a computer processor for executing computer program instructions; and
a non-transitory computer-readable memory storing computer program instructions executable by the computer processor to perform operations comprising:
determining a workload for each respective processing element in a group of processing elements based on an input operand and a weight operand, the respective processing element configured to perform a computation on the input operand and weight operand, the input operand comprising one or more activations of a convolution, the weight operand comprising one or more weights of the convolution,
determining that a workload of a first processing element in the group of processing elements is greater than a workload of a second processing element in the group of processing elements,
instructing the first processing element to start a first computation at a first time, and
instructing the second processing element to start a second computation at a second time, the second time later than the first time.

18. The apparatus of claim 17, wherein determining the workload of the respective processing element based on the input operand and the weight operand comprises:
determining the workload of the respective processing element based on an input sparsity bitmap and a weight sparsity bitmap,
wherein the input sparsity bitmap comprises a sequence of bits, each of which indicates whether a value of a respective activation in the input operand is zero, and the weight sparsity bitmap comprises another sequence of bits, each of which indicates whether a value of a respective weight in the weight operand is zero.

19. The apparatus of claim 17, wherein determining that the workload of the first processing element in the group of processing elements is greater than the workload of the second processing element in the group of processing elements comprises:
determining that a number of ones in a combined sparsity bitmap associated with the first processing element is greater than a number of ones in a combined sparsity bitmap associated with the second processing element.

20. The apparatus of claim 17, further comprising:
determining the first time and the second time based on the workload of the first processing element and the workload of the second processing element,
wherein the second computation ends no later than the first computation.
